(19) United States
(12) Patent Application Publication
(10) Pub. No.: US 2026/0364638 A1
(43) Pub. Date: Nov. 19, 2026

(54) MACHINE FOR FRACTIONATING AND/OR SEPARATING CEREAL PRODUCTS

(71) Applicant: SWISCA AG, Appenzell (CH)

(72) Inventors: Jonas Schär, Appenzell (CH); Reto Lehmann, Appenzell (CH)

(21) Appl. No.: 19/477,602

(22) PCT Filed: May 10, 2025
(86) PCT No.: PCT/EP2024/062954

§ 371 Date: Oct. 22, 2025

(30) Foreign Application Priority Data
May 10, 2023 (CH) CH000498/2023

(51) Int. Cl. B07B 1/38; B07B 1/46

(52) U.S. Cl. CPC B07B 1/38; B07B 1/46; B07B 2201/04

(57) ABSTRACT

A machine for fractionating and/or separating cereal products is designed to bring at least one sieve stack of sieve frames each with a sieve into oscillation movements. The machine includes a platform on which the sieve stack can be placed and a clamping element above the platform, wherein the sieve stack can be clamped between the platform and the clamping element in order to press the sieve frames of the sieve stack against one another and to thus fix them relative to the platform and the clamping element. The machine has a manually operable mechanical operating element as well as a transmission mechanism which converts a movement of the mechanical operating element into a vertical movement of the clamping element relative to the platform. Due to the vertical relative movement, the clamping element can be moved relative to the platform between a clamping position and an open position.

### BACKGROUND OF THE INVENTION

### Field of the Invention

The invention relates to a machine for fractionating and/or separating cereal products, for example to a plansifter.

### Description of Related Art

Machines for fractionating and/or separating cereal products on the one hand serve for the separation of constituents of a milling product into coarsely and finely grained constituents, and depending on the circumstances also constituents of different densities and/or for the removal of foreign bodies from the milling product. On the other hand, cereal purifying machines are also known as examples of such machines, in which cereal cleaning machines the cereal which has not yet been ground is separated from undesirable constituents which are included in the harvest.

The separating of the milling product into differently grained constituents is also called “grading” or “fractionating”. Plansifters are generally used in cereal mills for fractionating the cereal milling product between and after passages through the roller mill of a cereal mill. They can also be applied for a so-called control sifting, i.e. the sieving of flour which per se is ready for sale.

Plansifters and also certain types of cereal purifying machines include stacks of sieve frames each with a sieve which functions as a plane sieve. These stacks are brought into horizontally oscillating movements by a drive mechanism, in particular into circular oscillations in the plane of the sieve. It is due to this that they are subjected to relatively large accelerations.

It is particularly with larger plansifters that the sieves are often arranged in a housing which receives a plurality of sieves which form a so-called sieve compartment. The frames of the sieves are clamped with one another by way of a door being assembled on the sieve compartment at the front side and a clamping frame being pressed from above onto the sieve stack by a spindle drive—or possibly also by a spring force.

Open plansifters have also already been suggested and such include no sieve housing. Sieve stacks of open plansifters are located on a carrier frame and are clamped to the bottom by spindles and nuts via a clamping frame. The stacks can be laterally guided by parts of the carrier frame and of the clamping frame for the additional lateral retention.

Common to plansifters with a housing and plansifters with open sieve compartments is that the exchange of sieve frames requires quite some effort. Concerning plansifters with a housing, the door needs to be disassembled and the clamping frame moved upwards, whereupon the sieve frames which in any case are relatively inaccessible need to be removed to the front above the sieve frame which is to be exchanged, in order to have access to the sieve frames which are to be exchanged. Concerning plansifters with open sieve stacks, the nuts need to be removed individually by way of suitable tools or at least lifted, so that the clamping frame can be lifted and removed.

DE 10 2010 017826 A1 discloses a sieve machine, for example a wobble sieve machine or vibration sieve machine, amongst other things for the foodstuff industry. The sieve machine includes a clamping device with which an uppermost sieve insert or a hood can be clamped against a trough which lies at the bottom. This is effected in a tool-free manner via a so-called toggle lever. In DE 10 2010 017826 A1, a lever element with a hand grip is described as a “toggle lever”. With regard to the actual context of the definition of a toggle lever, this lever element forms a toggle lever together with a further lever element, specifically a rod.

DE 2011 115367 B3 discloses a wobble sieve machine. A clamping system is formed by individual hydraulic cylinders or pneumatic cylinders, which permit a clamping or lifting of the elements of the sieve construction by way of a synchronous moving of rods (lift rod).

DE 39 37 176 A1 shows a plansifter with a system with which one can selectively clamp or lift the sieves of a stack. D3 is characterised in that several pairs of so-called sieve frame ladders are present, by way of which the sieve frames are successively placed upon lateral rails (rest rails) on releasing the clamping, so that arbitrary sieve frames can be pulled out.

DE 1 203 102 discloses a so-called rapping mechanism. The test sieves are clamped in, for which a rod assembly is present.

U.S. Pat. No. 4,233,151 relates to a device for sorting wood chippings with a stack of vibrating sieves. The clamping of the sieves is effected with a type of toggle lever.

### SUMMARY OF THE INVENTION

An object of the present invention is to provide a machine for fractionating and/or separating cereal products which overcomes the disadvantages of the state of the art and renders an exchange of sieve frames more user friendly.

This object is achieved by a machine for fractionating and/or separating cereal products, the machine being designed to bring at least one sieve stack of sieve frames each with a sieve into oscillation movements, wherein the machine further includes a platform on which the sieve stack can be placed, and wherein the machine further includes a clamping element (for example a clamping frame) above the platform, wherein the sieve stack can be clamped between the platform and the clamping element, in order to press the sieve frames of the sieve stacks against one another and thus fix them relative to the platform and the clamping element. The machine includes a mechanical operating element which can be manually operated, as well as a transmission mechanism which converts a movement of the mechanical operating element into a vertical relative movement of the clamping frame relative to the platform.

Herein, according to definition, a transmission mechanism is to be understood as a mechanism in the technical sense, i.e. a coupling of the components of the mechanism, said coupling being designed such that each movement of an element effects a movement of other elements of the mechanism. By way of this, a transmission mechanism in particular differs from devices concerning which an operating element (for example a touch screen or also a push button or slide) is read out electronically, and a drive with its own individual energy source—for example an electrical, hydraulic or pneumatic drive—activates the desired movement as a reaction to a movement of the operating element.

By way of the transmission mechanism converting the movement of the mechanical operating element into the vertical relative movement, the drive for the vertical relative movement is provided by the operation of the mechanical operating element, i.e. the drive is effected in particular by muscle power. A separate energy source, in particular pneumatics or the like, is not necessary. In particular, the transmission mechanism can be purely mechanical.

The clamping frame can be moved relative to the platform between a clamping position and an open position by way of the vertical relative movement.

Such a vertical relative movement can include a vertical movement of the platform and/or of the clamping frame relative to the base, on which the machine is placed, i.e. it is possible for the clamping frame to be moved upwards, and/or for the platform to be moved downwards when they are moved from the clamping position into the open position- and vice versa.

In the open position, sieve frames can be simply removed and re-inserted or exchanged. In contrast to the state of the art, an operating person therefore merely needs to effect a movement of the operating element—for example an operating lever—in order to be able to remove the sieve frames.

In particular, the machine includes a mount which is suspended during the operation (i.e. is provided with fastening structures for a suspension device). The transmission mechanism for example can include deflection mechanics which are accommodated in the mount or are fastened to this, apart from a rod assembly—for example including a plurality of clamping rods—which is brought into a vertical movement by the deflection mechanics when the mechanical operating element is actuated.

In particular, the transmission mechanism can be such that a plurality of the clamping rods is moved synchronously in the same direction, in order to move the clamping element to the top or the platform to the bottom. The movement of the—one—mechanical operating element is therefore converted in particular into the synchronous vertical moment of several clamping rods (here for example, hollow rods, i.e. tubes which are mechanically sufficiently stable, or elements in other shapes which can mechanically have the function of a rod) can also be considered as “rods” here).

For example, the rod assembly can include four clamping rods which are moved synchronously and in the same direction given the vertical relative movement.

Such deflection mechanics can also be accommodated elsewhere than on or in the mount. In embodiments they are stationary, in particular in the context of them not being subjected to any vertical movement relative to the mount when the movement between the open position and the clamping position takes place.

In a special group of embodiments, the mount (with respect to the vertical) is arranged roughly in the middle, wherein an upper sieve stack lies on the mount and a lower sieve stack lies on a rest frame below the mount. The mount then on the one hand forms the clamping element for the lower sieve stack and the rest frame forms the platform for the lower sieve stack and is vertically movable by the transmission mechanism. On the other hand, the mount serves as a platform for the upper sieve stack by way of this lying thereon. A clamping frame serves as the clamping element for the upper sieve stack and can be moved by the mechanism and specifically in the vertical direction which is opposite to the movement of the rest frame. Then, on movement into the open position, the rest frame is simultaneously lowered and the clamping frame lifted, this being vice versa given the movement into the clamping position.

Accordingly, the rod assembly can include a first group of clamping rods—for example four upper clamping rods—which are moved synchronously by the transmission mechanism in a first direction in order to move the clamping frame, and a second group of clamping rods—for example four lower clamping rods—which by the transmission mechanism are moved synchronously with the first group of clamping rods and synchronously to one another in the direction which is opposite to the first direction, in order to move the rest frame.

However, there is also an option of two stacks which lie vertically above one another not being present. In contrast, according to a first possibility, a mount can be suspended such that it serves as a platform, and a clamping frame above the sieve stack which lies thereon serves as the clamping element. According to a second possibility, conversely a suspended mount can serve as the clamping element, and a rest frame which can be lowered relative to this by the transmission mechanism serves as the platform.

In particular, the transmission mechanism is designed such that a dead point is defined, and that given a movement into the clamping position, the mechanical operating element is moved towards the dead point and slightly beyond the dead point up to a first stop, so that a locking of the clamping frame relative to the platform is effected in the clamping position.

Such a self-locking design is particularly favourable since it effects a locking by the operation of the operating element itself: the operating person can bring the clamping device into the clamping position and reliably lock it in this by a single hand manipulation.

Herein, the first stop does not need to be formed by the operating element itself (i.e. the operating element does not itself need to physically abut anywhere) but can also be formed in the inside of the deflection mechanics or somewhere else; the first stop merely means than the relative movement in the direction towards the clamping position and generated by the operating element is mechanically limited.

In particular, the transmission mechanism can include a toggle lever mechanism. Such has the additional advantage that inherent of the design, the force transmission ratio becomes particularly large in the proximity of the dead point, which has the effect of the clamping force being able to be relatively large (i.e. the sieve frames of the sieves can be snugly pressed onto one another, even given a stack with a multitude of sieve frames), without the operating person having to apply an excessive amount of force.

In particular, such a toggle lever mechanism can include two lever elements which act together in the manner of a toggle lever, wherein one of the lever elements is connected to the rod assembly—in particular to a clamping rod—the rod assembly or clamping rod attaching to the clamping element or the platform respectively and being moved vertically by the toggle lever.

The other lever element of the toggle lever is typically pivotable about a fixed (fixed to the mount) attachment point, wherein such a pivoting movement is activated by the movement of the mechanical operating element. By way of this design, the clamping rod can be moved in a linearly vertical manner and for its part is not subjected to a pivoting movement, as would be the case if the clamping rod were itself to be part of a toggle lever.

As an alternative to the toggle lever mechanism, a cam disc whose cam curve defines the dead point is also considered.

A second stop can be defined towards the open position, in order to limit the relative movement. The open position can then be reached at the location of the second stop.

If the transmission mechanism includes a toggle lever, then a first lever element of the toggle lever can be formed by a lever wheel, or it can be driven by a lever wheel (the latter means that the rotation of the lever wheel can effect a pivoting movement of the—then separate—first lever element of the toggle lever about a fixed attachment point, corresponding for example to the axis of the lever wheel). A second lever element of the toggle lever on the one hand is articulately connected to the first lever element in order to form the toggle lever and on the other hand is connected to the rod assembly—thus for example to the clamping rod—in an articulated manner. The rod assembly is guided such that only a vertical movement is possible. A rotation of the lever wheel therefore effects the desired vertical relative movement.

An operating wheel which is connected to the mechanical operating element—for example operating lever—in a direct or indirect manner can be present for driving the lever wheel. Since in embodiments two clamping rods are moved synchronously and in the same direction each at both sides of a sieve stack, then accordingly two operating wheels can be present per side of the sieve stack, and these operating wheels are coupled—for example via a deflection wheel—such that they run synchronously.

If, as described above, the transmission mechanism effects the simultaneous movement of an upper and a lower rod assembly in opposite directions, then individual lever wheels which are driven for example by the same operating wheel can be present for the upper rod assembly and a lower rod assembly.

The rod assembly—independently of the possible presence or absence of rod assemblies which are moved in opposite directions—can include a clamping rod where the rod assembly is connected to the toggle lever, said clamping rod being led at both sides, i.e. the toggle lever is not only arranged along the clamping rod at one side, but at two opposite sides. For example, two lever discs can be present, the lever discs forming the second lever element of the toggle lever and being present parallel to one another at opposite sides of the clamping rod. A pin is then led through the clamping rod (through a horizontal bore) and is articulately connected to one of the lever discs each at both sides.

This guidance at both sides has the advantage that a jamming is reliably prevented even given the application of substantial forces, for example on movement beyond the dead point, since no torques can be coupled into the lever rod.

The guidance at both sides can also include the other elements of the deflection mechanics being present in duplicate and at both sides of the lever rod, thus as the case may be the operating wheel or the operating wheels, the lever wheel or the lever wheels, possibly the deflection wheel, etc.

In a group of embodiments, the machine includes a device which effects the targeted lifting or lowering of only a part of the sieve stack by way of a movement of the mechanical operating element. Such a device can be brought into targeted engagement with one of the sieve frames of the sieve stack (the “dedicated” sieve frame) by a user, in order, given a movement from the clamping position into the open position, to lift this sieve frame together with all sieve frames which lie thereabove or to prevent this sieve frame together with all sieve frames lying thereabove, from participating in a lowering movement. This permits the removal—and if necessary an exchange—of the sieve frame directly below the dedicated sieve frame when the device is in the open position—and specifically, in contrast to the state of the art, without all sieve frames which are arranged above the sieve frame to be removed likewise having to be removed. This represents a considerable advantage due to the fact that the work effort for the operator as well as the standstill times, are able to be significantly reduced.

If the vertical relative movement of the clamping element relative to the platform includes an upward movement of the clamping element with respect to the mount, then the device can be fastened to the clamping rods which run between the mount and the clamping element. Given a movement of these clamping rods upwards relative to the housing, the device then participates in this movement and lifts the dedicated sieve frame and the sieve frames lying thereabove together with the clamping element.

If the vertical relative movement of the clamping element relative to the platform includes a downward movement of the platform with respect to the mount, then the machine can include fastening elements which given the vertical relative movement remain stationary relative to the mount and are suitable for fixing the device. Such fastening elements can include for example tubes which surround the clamping rods (possibly the lower clamping rods) which lead downward from the mount. Alternatively, they can also be fastening rods which run parallel to these clamping rods and which in contrast to the clamping rods are assembled in a manner fixed to the mount and are not vertically moved when the operating element is moved.

In both cases, the device can include a plurality of riders which can be fastened at a selectable position on each one of the clamping rods or on each one of the fastening elements.

The riders or an element which can be fastened to the riders—for example a connection element between two riders—herein engage below the dedicated sieve frame. The fastening can be effected for example such that the respective rider is clamped on the clamping rod or the fastening element when the dedicated sieve frame is pressed downwards relative to the clamping rod or the fastening element on account of its weight (and possibly the weight of the sieve frames which lie thereon). It is due to such a simple design that it can be ensured that the riders remain stable relative to the clamping rod or the fastening element under a weight load, independently of the weight of the sieve frames.

In both cases, it can be advantageous if the elements (clamping rods; fastening elements) on which the device—for example the riders of the device—can be fixed, have a constant cross section (i.e. the cross section is not dependent on the axial, i.e. vertical position) and/or if structures for the fixation of the device are present at regular distances which correspond to the vertical extension of the sieve frames.

### BRIEF DESCRIPTION OF THE DRAWINGS

Embodiment examples of the invention are hereinafter described by way of drawings. In the drawings, the same reference numerals denote the same or analogous elements. The drawings show elements which partly correspond to one another in sizes which differ from figure to figure. There are shown:

FIG. 1 a view of a plansifter with an upper sieve stack and a lower sieve stack;

FIG. 2 a view of a plansifter according to FIG. 1, in the open position;

FIG. 3 a view of the deflection mechanics, wherein from a viewers point of view, elements of the deflection mechanics which lie at the front are drawn apart in the manner of an exploded representation;

FIG. 4 a sectioned representation of the deflection mechanics in the clamping position, according to FIG. 1;

FIG. 5 a sectioned representation in the open position, corresponding to FIG. 4;

FIG. 6 a detail-like representation of the elements which are represented in FIG. 4, with an illustration of the toggle lever principle and the self-locking;

FIG. 7 a schematic representation of a plansifter with devices for the targeted lifting and lowering each of a part of the sieve stack; and

FIG. 8 a representation of a plansifter of FIG. 7 in the open position.

### DETAILED DESCRIPTION OF THE INVENTION

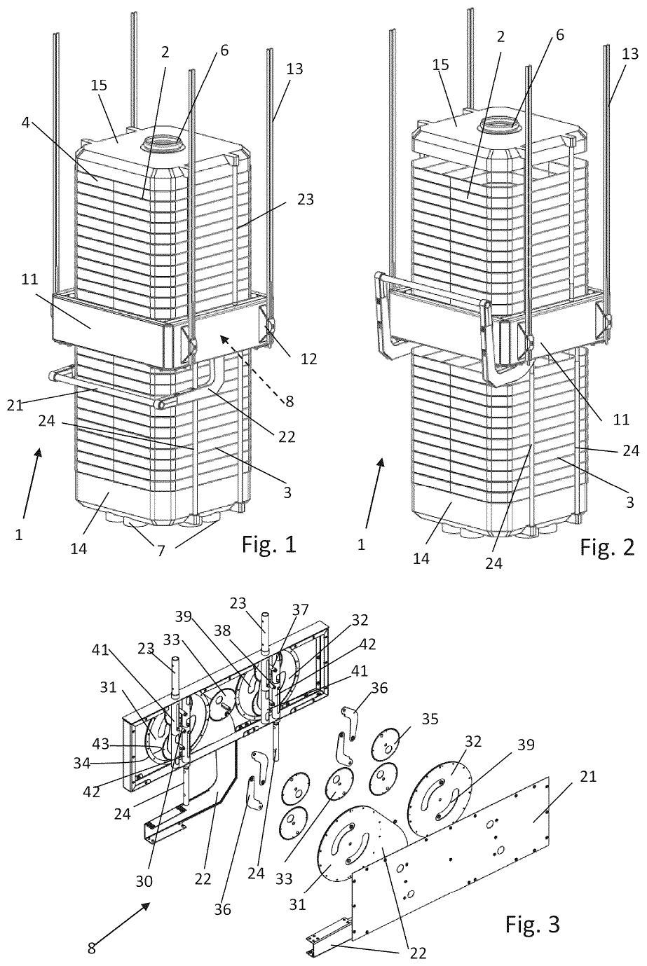

FIG. 1 shows a plansifter 1 with a single sieve stack pair with an upper sieve stack 2 and a lower sieve stack 3. In the represented embodiment example, the plansifter is an open plansifter in which the sieve frames 4 are present with the sieves (not visible in FIG. 1, but designed for example as is described in the Swiss patent application 1319/2022) without the housing which surrounds the sieve stacks.

In the represented embodiment example, the mount 11 is for the sieve stacks and serves as a second platform and as a second clamping element. The mount 11 is arranged in the middle in the sense that the upper sieve stack 2 lies on the mount 11 and the lower sieve stack is suspended thereon, thus arranged below the mount 11. As is known from the Swiss patent application 722/2022, the mount 11 furthermore includes a drive module with an inertial weight, so that the drive is likewise arranged at the middle and the plansifter is suitable for a modular construction. Such a modular construction means that a suitable number of units of an upper stack, a lower stack and drives can be arranged next to one another and for example form one or more rows. In such a case, in comparison to the embodiment of FIG. 1, it is merely the mount 11 which needs to be modified accordingly and be designed for receiving several sieve stack pairs, as is likewise shown in 722/2022.

The mount 11 includes fastening structures 12 in order to suspend the complete plansifter 1 by way of a suspension device, for example by suspension rods 13.

The sieve frames of the upper sieve stack 2 lie on the mount and/or an element which is fastened thereto—for example the drive module. The sieve frames of the lower sieve stack lie on a rest frame 14 which is suspended on the mount via lower clamping rods 24 which are described in more detail hereinafter. The rest frame 14 also serves as a sieve product outlet by way of it including lower-side exits 7 for run-out conduits which can be fastened thereto.

A clamping frame 15 which also serves as an inlet frame is present at the upper side of the upper sieve stack 2. This includes at least one upper-side entry 6 at which an entry conduit can be fastened and via which the product to be sieved can be fed.

The clamping system includes an operating lever with an operating lever rod 21 and an operating lever arm 22 each at both sides (with respect to the lower and operating lever). By way of a manual actuation—on standstill of the plansifter—the operating lever can be pivoted upwards from the position which is drawn in FIG. 1 into the position which is represented in FIG. 2. By way of this, on the one hand two upper clamping rods 23 (three of the four upper clamping rods are covered in FIG. 1 and FIG. 2) are displaced upwards each at both sides. On account of this, the clamping frame 15 which is fastened thereto is lifted. Simultaneously, the two lower clamping rods 24 are displaced downwards each at both sides. By way of this, the rest frame 14 with the lower sieve stack 3 which lies thereon is lowered. In this configuration, as is shown in FIG. 2, frames can be removed from the upper sieve stack and/or the lower sieve stack and—for example after an exchange of the sieve or a cleaning etc.—can be inserted again or replaced.

The deflection mechanics 8 of the transmission mechanism which converts the movement of the operating lever into the vertical movement of the upper and lower clamping rods is attached to the mount 11 at the inner side each at both sides.

In embodiments with more than one sieve stack pair each with an upper and a lower sieve stack, each sieve stack pair can each include an individual transmission mechanism. It would also be possible to group together groups of sieve stack pairs or even all sieve stack pairs and to provide them with a common transmission mechanism.

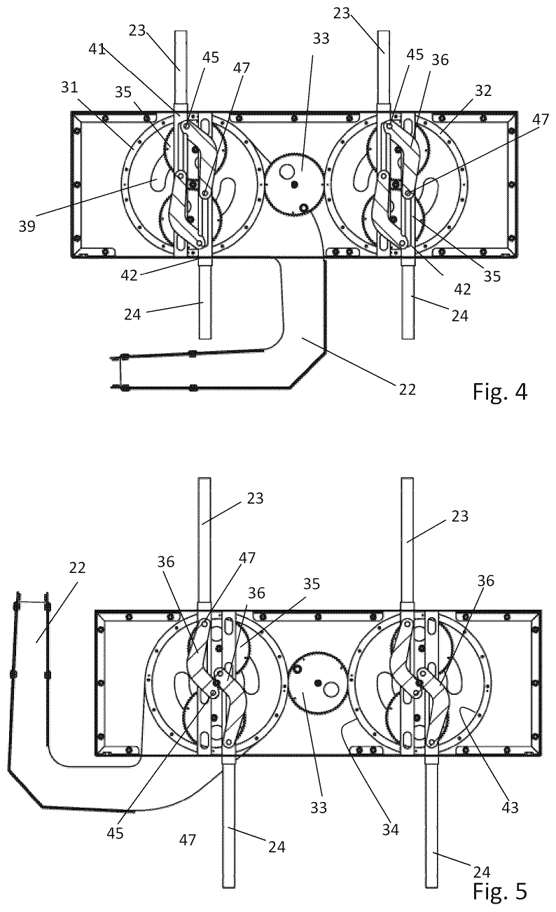

The transmission mechanism is hereinafter described by way of FIGS. 3-6.

The lever arm 22 is connected to a first operating wheel 31 in direct manner, the operating wheel being rotated about the pivot axis of the operating lever (operating lever axis 30) by way of the pivoting movement of the lever arm 22. In the represented embodiment example, the first operating wheel 31 as also a second operating wheel 32 which is rotatable about an operating wheel axis 38 each include an operating wheel disc with bent elongate holes 39 which are yet described hereinafter and with an outer toothing 34 along at least a part of its circumferential line, as well as fastened thereto, an operating wheel ring with an inner toothing 43. In the represented embodiment example, the operating wheel disc of the first operating wheel 31 is formed as one piece with the lever arm 22 and is formed by a portion of the lever arm 22.

The rotation movement of the first operating wheel 31 which is created by the pivoting movement of the lever arm 22 is transmitted via the outer toothing 34, a deflection wheel 33 and the outer toothing 34 of the second operating wheel 32 onto the second operating wheel 32 which has the same outer diameter as the first operating wheel 31 and therefore rotates synchronously with the first operating wheel 31. The inner toothings 43 of the first and the second operating wheel each effect a rotation of in each case two lever wheels 35 which are formed as gearwheels 35 and are arranged within the operating wheel ring.

A lever disc 36 is fastened to each of the lever wheels via a first pin 45 and for its part is connected to the upper or lower clamping rod 23; 24 via a second pin 47. The upper or lower clamping rod 23, 24 is led in a first guide tube 41 or second guide tube 42 respectively and for this reason can only be moved vertically. The rotation of the lever wheels 35 which is caused by the rotation of the first and second operating wheel 31, 32 therefore via the lever discs 36 effects the displacement of the upper and lower clamping rods to the top or bottom, said displacement being represented in FIGS. 1 and 2.

Since the two operating wheels rotate synchronously, in each case the front and rear (with respect to the view from where the operating person stands i.e. in the figures the right and the left) upper and lower clamping rod are likewise displaced synchronously. Since the construction according to FIG. 3 with the deflection mechanics and housing as well as clamping rods is present on both sides of the sieve stack (again with regard to the view from where the operating person stands, i.e. in front of and behind the sieve stacks in the figures) in a manner mirrored to one another, in total four upper clamping rods 23 and four lower clamping rods 24 are moved synchronously when the operating lever is actuated, in order to vertically move the rest frame 14 and the clamping frame 15 in a stable manner with regard to the orientation.

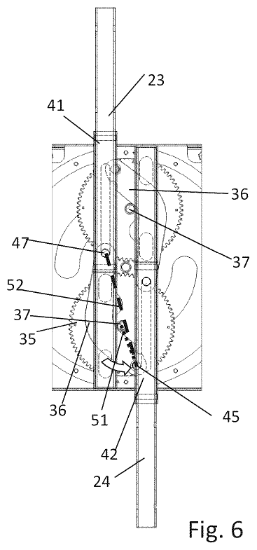

As one can see particularly well in FIG. 6, the lever wheels 35 together with the lever discs 6 each form a toggle lever. In FIG. 6, the first connection 51 between the stationary rotation axle 37 of the lever wheel 35 on the one hand and the lever joint—corresponding to the axis of the first pin 45—on the other hand are represented in a dashed manner. The second connection 52 between the lever joint on the one hand and the second pin 47—whose position is only movable vertically—is likewise represented in a differently dashed manner. FIG. 6 shows the situation in which the clamping frame 15 and the rest frame 14 are in the clamping position and the operating lever is pivoted downwards, thus in the position according to FIG. 1. One can see that the toggle lever is extended beyond the dead point (at which the first connection 51 and the second connection 52 are co-linear) at the end of the movement from the open position into this clamping position (represented in FIG. 6 by the solid arrow), until something abuts on the stop which in the drawn embodiment example is formed by the abutting of the lever discs 36 on the axles 37 of the lever wheels 35; other mechanical stops would also be conceivable. The axles 37 of the lever wheels 35 are also the reason for the bent shape of the lever discs 36.

The clamping system is locked in the clamping position by way of moving the toggle lever (lever wheel 35 with lever disc 36) past dead centre and the abutting on the stop. The weight of the lower sieve stack 3 which lies on the rest frame 14, as well as the force of the sieve stacks counter to the clamping force (due to the always present elasticity) prevent the locking from opening. This is effected by way of the toggle lever firstly having to be moved back beyond the dead point counter to these forces, in order to be moved away from the clamping position. Concerning this movement back beyond the dead point, the second pins 47 of the lower clamping rods 24 and herewith the lower clamping rods with the rest frame are moved slightly upwards and the second pins 47 of the upper clamping rods 23 and herewith the upper clamping rods 23 with the clamping frame are moved slightly downwards, counter to the force counter to the clamping force, before the clamping force releases after the movement beyond the dead point (counter to the direction of the solid arrow in FIG. 6), which renders necessary an active actuation/unlocking.

In the embodiment example according to FIG. 1-6 , the movement into the open position is effected in a manner assisted by the weight of the lower sieve stack, whereas the movement into the clamping position is effected counter to this weight force and thus entails a certain force effort. It is also possible to set the force which is necessary for the movements by way of separate means, for example a spring device. In particular, this can be of interest in embodiments in which the relative movement of the clamping frame and the platform does not include a movement of the platform (i.e. if on transition into the open position it is only the clamping frame which is moved upwards), but not just in such embodiments.

An optional feature of the represented embodiments is also to be seen in particular in FIG. 3. The upper and lower clamping rods are each guided at both sides. The first operating wheel 31, the second operating wheel 32, the deflection wheel 33, the lever wheels 35 and the lever discs 36 are each present at both sides of the upper clamping rods 23 and at both sides of the lower clamping rods 24—thus in FIG. 3 in front of the upper and lower clamping rods and behind the upper and lower clamping rods. The axles of the operating wheels 31, 32 of the deflection wheels 33 and of the lever wheels 35 each connect the front wheel to the respective rear wheel, i.e. they are common to the respective front and rear wheel. The lever arm 22 of the operating lever is accordingly also of two parts, as is illustrated in FIG. 6 (in FIG. 6 the elements which each lie in front of the upper and lower clamping rod are drawn staggered whilst the corresponding elements which lie therebehind are illustrated in the assembled state, so that one can see their interaction).

The elongate holes 39 are present in first and second operating wheels, so that the axle stubs of the axles 37 of the lever wheels 35 which project at the outer side and the respective operating wheels are not in the way of one another.

In FIG. 3 one can likewise see that a housing is present in the represented embodiment, said housing on both sides each including a cover plate 21 and receiving the deflection mechanics 8, thus the operating wheels 31, 32, deflection wheels 33, lever wheels 35 and guide tubes 41, 42. The housing is at least partly open to the bottom for the lever arm 22.

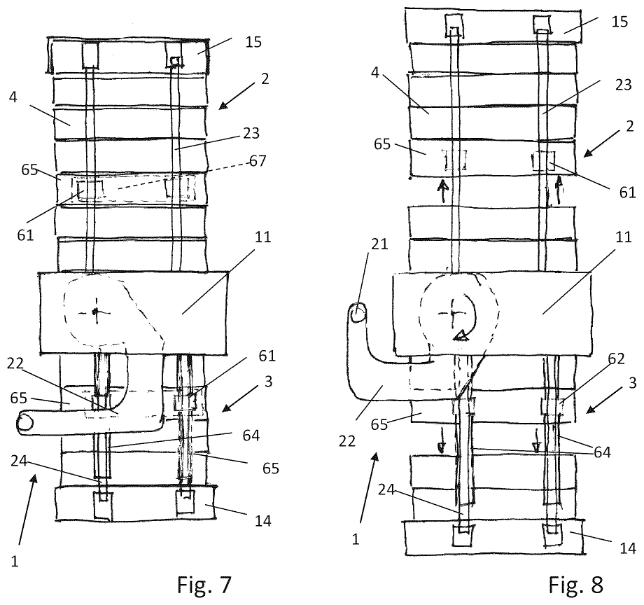

FIG. 7 schematically shows a plansifter 1 which is constructed similarly to that of FIG. 1, with a single sieve stack pair with an upper sieve stack 2 and a lower sieve stack 3. The plansifter 1 is characterised by a device for the targeted lifting of a part of the upper sieve stack 2 and a device for the targeted lowering of a part of the lower sieve stack 3.

The first device (device for the targeted lifting of a part of the upper sieve stack 2) includes one rider 61 per upper clamping rod 23, the rider being able to be attached at a location which is selectable with respect to the vertical relative to the clamping rod 23. Each rider 61 is designed such that at least when a weight force presses it downwards relative to the clamping rod 23, it is fastened to this and thus given the movement from the clamping position (FIG. 7) into the open position (FIG. 8) it participates in the upward moment of the upper clamping rod 23, as is indicated in FIG. 8 by arrows. The riders 61 or a connection element 67 which is fastened to this are herein engaged with the dedicated (dependent on the selected vertical position of the riders and possibly of the connection element) clamping frame 65, for example by way of a structure of the riders or of the connection element engaging below this clamping frame or a structure of the clamping frame. The dedicated clamping frame 65 with the riders 61 and possibly the connection element 67 are thus lifted.

The device can include identically designed elements (riders 61, optionally connection element 67) at the side which is opposite to the represented side of the plansifter 1 (thus at the rear side with respect to the representation in FIGS. 7 and 8), said elements being paced at the same vertical position.

The second device (device for the targeted lowering of a part of the lower stack 3) is designed analogously to the first device and can be identical to this. (In practise then only a single such device which can be used selectively as the first device or as the second device can be present, in contrast to that which is illustrated in FIG. 7 and FIG. 8). Accordingly, it likewise includes riders 61 and optionally a connection element 67. In contrast to the first device, it is not fastened to the respective (lower) clamping rod 24, but on fastening elements 64 which are provided for this and which here are represented as tubes which surround the lower clamping rods 24 at least in an upper region. On lowering the rest frame 14, the second device prevents the dedicated sieve frame 65 with the sieve frames which lie thereon from being co-lowered, which is likewise represented by arrows in FIG. 8.

The optional connection elements 67 on the one hand can include the structures which interact with the sieve frame which is selected according to the situation (the dedicated sieve frame), in order to lift this or to prevent its lowering. Independently of whether this is the case or not, they have the function of permitting the simultaneous movement of the two riders 61 by way of a single hand manipulation. In particular, they can be designed such that an operation (a placement at the selected position, for the engagement with the dedicated sieve frame) is possible from the grip side, thus in FIG. 7 and FIG. 8 from the left. The operation is then also possible if several sieve stacks are arranged next to one another.

In the open position according to FIG. 8, the sieve frame below the dedicated sieve frame in the upper sieve stack and in the lower sieve stack can each be simply removed and when required can be exchanged.

The invention would also be able to be implemented if no subdivision between the upper sieve stack and the lower sieve stack and accordingly no second platform were to be present, and the transition mechanism, for example only the rest frame, were to lower or only the clamping frame were to lift.

The invention could also be used for plansifters with closed sieve boxes, wherein then for example the base or the cover would be able to be lifted or lowered, in order to release the clamping force between the sieve frames within the sieve box, so that the sieve frames can be removed.

1. A machine for fractionating and/or separating cereal products, which is designed to bring at least one sieve stack of sieve frames each with a sieve into oscillation movements, wherein the machine comprises a platform on which the sieve stack can be placed, and wherein the machine further comprises a clamping element above the platform, wherein the sieve stack can be clamped between the platform and the clamping element, in order to press the sieve frames of the sieve stack against one another and to thus fix them relative to the platform and the clamping element, wherein a manually operable, mechanical operating element as well as a transmission mechanism which converts a movement of the mechanical operating element into a vertical relative movement of the clamping element relative to the platform.

2. The machine according to claim 1, comprising a mount with fastening structures for a suspension device.

3. The machine according to claim 1, wherein the transmission mechanism comprises deflection mechanics and a rod assembly, wherein the deflection mechanics are designed to bring the rod assembly into a vertical movement when the mechanical operating element is actuated, said vertical movement effecting the vertical relative movement.

4. The machine according to claim 3, wherein the deflection mechanics are designed to move several clamping rods of the rod assembly in a synchronous manner in the same and/or in an opposite direction.

5. The machine according to claim 4, wherein the rod assembly comprises four clamping rods which given the vertical relative movement are moved synchronously and in the same direction.

6. The machine according to claim 3, wherein the rod assembly comprises a first group of clamping rods which, given the movement of the operating element, is moved synchronously in a first direction by the transmission mechanism, and a second group of clamping rods which herein, by the transmission mechanism, is moved synchronously with the first group of clamping rods and synchronously with one another in a direction which is opposite to the first direction.

7. The machine according to claim 3, comprising the mount, wherein the deflection mechanics are present on the mount or in the mount.

8. The machine according to claim 3, comprising a lower rest frame below the mount and clamping frame above the mount, wherein the transmission element is designed, given an actuation of the mechanical operating element, to vertically move the rest frame and the clamping frame in opposite directions, by which means the rest frame forms the platform for a lower sieve stack and the mount the platform for an upper sieve stack, and the mount forms the clamping element for the lower sieve stack and the clamping frame the clamping element for the upper sieve stack.

9. The machine according to claim 1, wherein the transmission mechanism is designed such that a dead point is defined, and that given a movement into the clamping position, the mechanical operating element is moved towards the dead point and beyond the dead point up to a first stop, so that a locking of the clamping frame relative to the platform is effected in the clamping position.

10. The machine according to claim 9, wherein the transmission mechanism comprises a toggle lever, wherein the dead point is a dead point of the toggle lever.

11. The machine according to claim 10, wherein the toggle lever comprises two lever elements which together act as a toggle lever, wherein one of the lever elements is pivotable about a fixed attachment point and the other of the lever elements is connected to the rod assembly which attaches to the clamping element or the platform and is vertically movable by the toggle lever.

12. The machine according to claim 10, wherein the movement of the mechanical operating element generates a rotation movement of a lever wheel which forms or drives a first lever element of the toggle lever, wherein a second lever elements of the toggle lever is connected on the one hand to the first lever element and on the other hand in an articulated manner to the rod assembly, in order to effect the vertical relative movement.

13. The machine according to claim 10, wherein the rod assembly comprises a clamping rod which is guided at both sides.

14. The machine according to claim 13, wherein a pin is led through the clamping rod and is articulately connected each at both sides to a lever disc, said lever disc forming the second lever element of the toggle lever.

15. The machine according to claim 1, comprising a device which is configured to effect a targeted lifting or lowering of only a part of the sieve stack when the mechanical operating element is moved, in order to effect the vertical relative movement.

16. The machine according to claim 15, wherein the device is configured to be fastened to the rod assembly which is subjected to the vertical relative movement.

17. The machine according to claim 15, wherein the device is configured to be fastened to fastening elements which remain stationary relative to the mount given the vertical relative movement.

18. The machine according to claim 16, wherein the device comprises a plurality of riders which can be fixed at a selectable position relative to the rod assembly or to the fastening elements.
